(19) United States
(12) Patent Application Publication
(10) Pub. No.: US 2011/0029670 A1
(43) Pub. Date: Feb. 3, 2011

(54) ADAPTING PUSHED CONTENT DELIVERY BASED ON PREDICTIVENESS

(75) Inventors: Johannes Klein, Sammamish, WA (US); Thomas W. Kuehnel, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/533,809

(22) Filed: Jul. 31, 2009

(51) Int. Cl. G06F 15/173; G06F 15/16

(52) U.S. Cl. 709/225; 709/224

(57) ABSTRACT

Correlating user activity and location-based prediction of network access events with the delivery of pushed content to a computing device. Location information for the computing device is received by the computing device. One or more network access events are predicted, or network access characteristics are determined, based on the location information and user activity on the computing device. The computing device adjusts delivery or receipt of the pushed content based on the predicted network access events or the determined network access characteristics. For example, data is pre-fetched prior to occurrence of the predicted network access events, or data retrieval requests are postponed until after the occurrence of the predicted network access events.

### BACKGROUND

Location-based information retrieval frameworks provide location information to mobile computing devices such as mobile telephones. For example, an application executing on one of the mobile computing devices requests the location information to provide navigation services to a user, or display a map of the current location to the user. Users may also subscribe or register with content providers to receive content of interest when in particular locations. The content providers asynchronously push the desired content to the users when the content becomes available and when the users are in the particular locations.

Existing content delivery systems, however, fail to consider the ability of the mobile computing devices to access a network to receive the content. For example, as the mobile computing devices change locations, the ability of the mobile computing devices to access the network also changes. Further, existing content delivery systems push content without regard to the activity level on the mobile computing devices. As such, battery life and the user experience may degrade as a result of the unpredictable content delivery.

### SUMMARY

Embodiments of the disclosure adapt resource retrieval based on device location and user interaction. A computing device receives pushed content and location information via a network. User activity on the computing device is assessed. Network access characteristics for the computing device are determined based at least on the received location information. Receipt of the pushed content is adjusted by the computing device based on the determined network access characteristics and the assessed user activity.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a computing device accessing remote resources and receiving pushed content from content providers.

FIG. 2 is an exemplary block diagram illustrating a computing device having a memory area storing computer-executable components for correlating location and user activity with the delivery of pushed content.

FIG. 3 is an exemplary flow chart illustrating application programs modifying delivery of pushed content based on a predicted network event.

FIG. 4 is an exemplary flow chart illustrating a computing device adjusting receipt of pushed content based on current network access characteristics.

Corresponding reference characters indicate corresponding parts throughout the drawings.

### DETAILED DESCRIPTION

Referring to the figures, embodiments of the disclosure enable, at least, resource retrieval to be adapted based on location of a computing device 102 and user activity on the computing device 102. The ability of computing devices 102 such as mobile computing devices to change locations often affects the ability of the computing devices 102 to access a network 108 to receive content. Aspects of the disclosure correlate location and user activity on the computing devices 102 with network access to manage delivery of content. For example, if the computing device 102 is idle (e.g., no user interaction) and the network access is predicted to be stable based on the location of the computing device 102, the computing device 102 may batch or postpone delivery of content to reduce power consumption. Alternatively, if the computing device 102 is predicted to lose network connectivity based on the location of the computing device 102, the computing device 102 proactively requests delivery of content or other resources prior to the loss of network connectivity. As such, embodiments of the disclosure adapt resource retrieval to computing device location and to a state of the computing device 102.

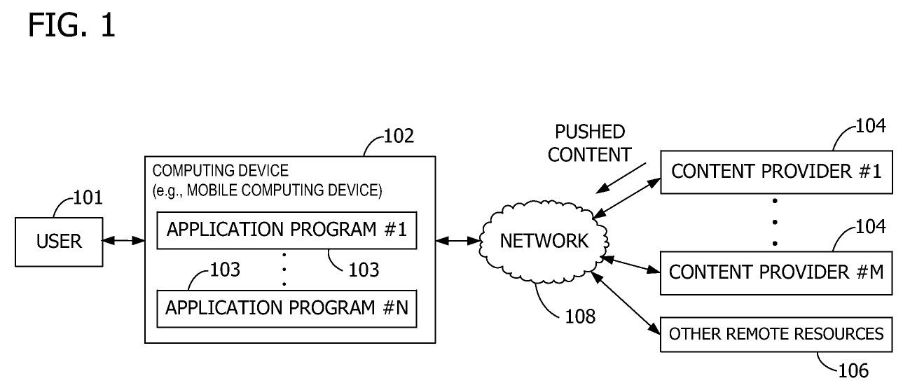

Referring again to FIG. 1, an exemplary block diagram illustrates the computing device 102 accessing resources. The computing device 102 has one or more application programs 103 that, when executed, access the resources. The application programs 103 include, for example, application program #1 through application program #N. The application programs 103 include, for example, messaging programs (e.g., electronic mail or instant messaging), navigation programs, neighborhood search programs, etc. In the example of FIG. 1, the resources are remote from the computing device 102 (e.g., accessible by one or more networks such as network 108). Further, the exemplary resources illustrated include one or more content providers 104 such as content provider #1 through content provider #M, or other entities publishing content. The content providers 104 include servers (e.g., front-end servers) or other computing devices transmitting data to the computing device 102 via the network 108. In some embodiments, the content providers 104 and other remote resources 106 are considered part of the network 108. The content providers 104 in this example push content to the application programs 103 executing on the computing device 102. That is, in some embodiments, the content providers 104 initiate transmission of the content to the computing device 102 without an explicit request from the computing device 102 for each transmission. The pushed content includes, for example, news feeds, stock quotes, electronic mail, instant messaging, social networking messages, and the like. The computing device 102 then provides the pushed content to a user 101 of the computing device 102. The computing device 102 may also access other remote resources 106 such as, for example, databases, cloud storage, or peer devices.

While a single computing device 102 is shown in the example of FIG. 1 for clarity of illustration, a plurality of computing devices 102 are contemplated. In such embodiments, the content providers 104 push the content to one or more of the plurality of computing devices 102.

The computing device 102 in FIG. 1 may represent, for example, a mobile computing device communicating with the resources via a cellular network. Other examples of the computing device 102 include, but are not limited to, laptop computers, netbooks, digital cameras, digital video cameras, gaming consoles (including handheld gaming consoles), portable music players, personal digital assistants, information appliances, personal communicators, and any other computing devices 102 of the users 101. In some embodiments, the computing device 102 includes a computing device remote from the user 101, yet accessible by the user 101. Such a computing device includes, for example, a server computing device and a peer computing device.

The network 108 includes any wired or wireless network or combination of networks including, but not limited to, cellular networks, intranets, the Internet, and BLUETOOTH brand wireless networks.

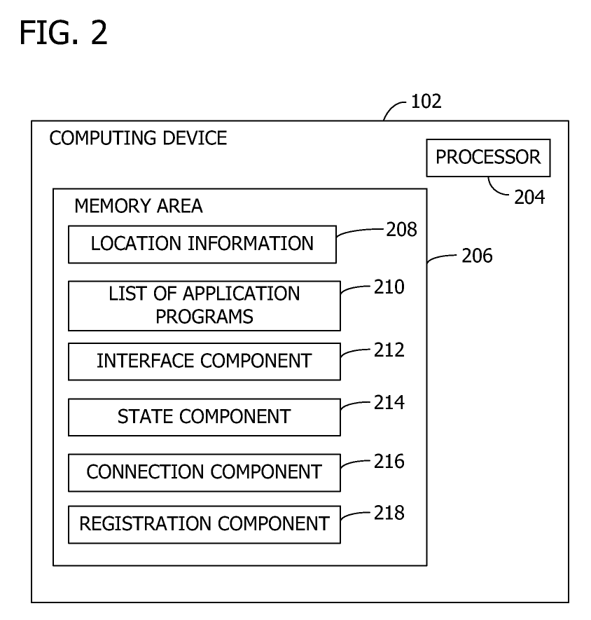

As described next in FIG. 2, the computing device 102 or application programs 103 in some embodiments coordinate or modify receipt or delivery of the pushed content based on user activity and an ability of the computing device 102 to access the resources.

Referring next to FIG. 2, an exemplary block diagram illustrates the computing device 102 having a memory area 206 storing computer-executable components for correlating location and user activity with the delivery of pushed content. The computing device 102 includes at least the memory area 206 and a processor 204. In FIG. 2, the memory area 206 is within the computing device 102. However, the memory area 206 or any of the data stored thereon may be associated with any server or other computer, local or remote from the computing device 102 (e.g., accessible via a network). For example, the memory area 206 may be implemented as cloud storage.

The memory area 206, or other computer-readable media, stores location information 208 for the computing device 102. For example, the location information 208 identifies and/or describes locations of interest to the computing device 102. For example, when the computing device 102 is a mobile computing device, the location information 208 includes a position of the mobile computing device (e.g., from a global positioning system), landmarks, points of interest, airports, and network access points. The location information 208 is obtained from, for example, a location information retrieval framework or other system providing the location information 208. The location information 208 is provided to the mobile computing device when updates are available. For example, the mobile computing device will receive updated location information 208 as the mobile computing device changes locations (e.g., moves geographically).

The memory area 206 further stores a list 210 of the application programs 103 that, when executed by the computing device 102, receive the pushed content or otherwise access the remote resources. The memory area 206 also stores computer-executable components for implementing aspects of the disclosure. Exemplary components include an interface component 212, a state component 214, a connection component 216, and a registration component 218.

The interface component 212, when executed by the processor 204, causes the processor 204 to receive the location information 208 for the computing device 102. The location information 208 is received from a location information service provider, or other system. The state component 214, when executed by the processor 204, causes the processor 204 to monitor or assess user interaction, activity, behavior, or patterns with the computing device 102. In some embodiments, there are two states: active and inactive. The computing device 102 is in the active state when the user 101 is interacting with the computing device 102, has recently interacted with the computing device 102, or is otherwise paying attention to the computing device 102. Delivery of fresh content to the computing device 102 improves the user experience if the user 101 is actively engaged with the computing device 102 and ready to consume the delivered content. The computing device 102 is in an inactive state when the user 101 is not currently interacting with the computing device 102, has not recently interacted with the computing device 102, or is otherwise not paying attention to the computing device 102. The inactive state may correspond to a sleep mode, a reduced power mode, or other idle state. The state component 214 transitions the computing device 102 between the active state and the inactive state based on the monitored user activity.

The connection component 216, when executed by the processor 204, causes the processor 204 to predict a network access event based on the received location information 208 and the monitored user interaction. The network access event includes any change in network access or ability of the computing device 102 to access the network 108. Exemplary network access events include a loss of network access, discovery of a network access point, a change in bandwidth, and a change in network service providers. Additional examples of network access events that are predictable based on the location of the computing device 102 include the user 101 about to enter an airplane (e.g., the computing device 102 is at an airport location), tunnel (e.g., the computing device 102 is on a road that has an upcoming tunnel), or elevator (e.g., the computing device 102 is approaching a bank of elevators).

The registration component 218, when executed by the processor 204, causes the processor 204 to notify one or more of the application programs 103 of the network access event predicted by the connection component 216. In some embodiments, the registration component 218 may notify the application programs 103 that are known to access the resources via the network 108. For example, the application programs 103 that use the network 108 to access the resources may register with the registration component 218 or otherwise inform the computing device 102 of the use of the network 108 to access the resources. Alternatively or in addition, the computing device 102 may monitor access to the network 108 and build/update the list 210 of application programs 103 stored in the memory area 206 of FIG. 2.

In other embodiments, the registration component 218 notifies each of the application programs 103 executing on the computing device 102. The application programs 103 that do not access the network 108 disregard the notification, while the application programs 103 that expect to access the network 108 may take action based on the predicted network event.

Based on the predicted network event, the application programs 103 communicate with the network 108 or content providers 104 to adjust the receipt of the pushed content. In some embodiments, the application programs 103 may enable or disable delivery of the pushed content based on the predicted network event. For example, data is opportunistically pre-fetched prior to occurrence of the predicted network access events, or data retrieval requests are postponed until after the occurrence of the predicted network access events. For example, if the computing device 102 is aware of the destination of an upcoming airplane flight, the computing device 102 proactively fetches resources related to the destination prior to boarding. The fetched resources may include dining guides or assisted GPS data for the destination. The destination of the airplane flight may be conveyed to the computing device 102 by the user 101 or inferred by various means such as by correlating a location of the computing device 102 at the airport (e.g., gate number) with an airport or airline departure or booking system.

In some embodiments, in addition to predicting the network access event, the connection component 216 further determines a cost associated with receipt of the pushed content by the computing device 102 before and/or after occurrence of the predicted network access event. The cost may be defined absolutely or relatively in qualitative or quantitative terms. The cost may reflect a network cost, a performance cost (e.g., performance of the computing device 102), or other factor. For example, the connection component 216 may determine that the cost of receiving the content will increase after the network access event (e.g., entering a roaming area), or will decrease after the network access event (e.g., leaving the roaming area). Aspects of the disclosure proactively receive or retrieve content when the determined cost is low (e.g., the computing device 102 is connected to Wi-Fi) while postponing receipt of the content when the determined cost is high (e.g., the computing device 102 is roaming, or has a low battery level). The connection component 216 may also weigh the level of user activity on the computing device 102 when determining the cost to gauge whether performance will degrade or improve after the network access event.

The registration component 218 notifies the application programs 103 of both the predicted network access event and the cost determined by the connection component 216. In some embodiments, the connection component 216 compares the determined cost with a predefined threshold. The determined cost is provided to the application programs 103 if the cost exceeds the predefined threshold (e.g., the change represented by the cost is significant), but withheld from the application programs 103 if the cost is less than the predefined threshold (e.g., the change represented by the cost is insignificant).

In the example description above, the connection component 216 predicts the network access event separate from determining the cost. In other embodiments, the network access event is predicted at least in part by the determined cost. For example, a determined cost that exceeds a predefined threshold triggers or defines the network access event.

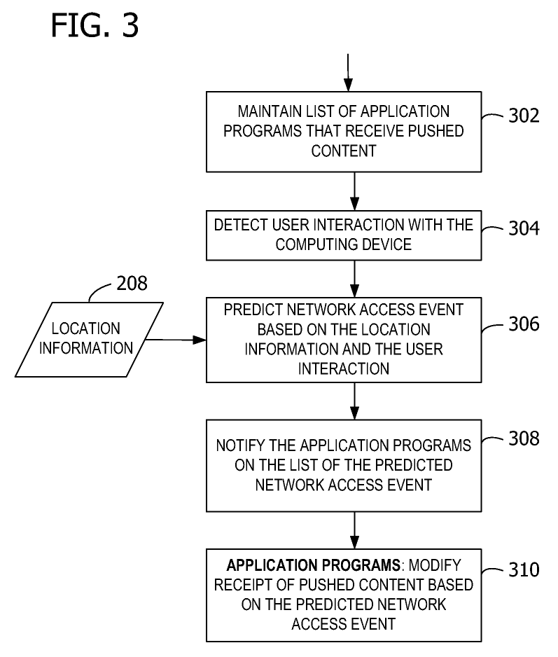

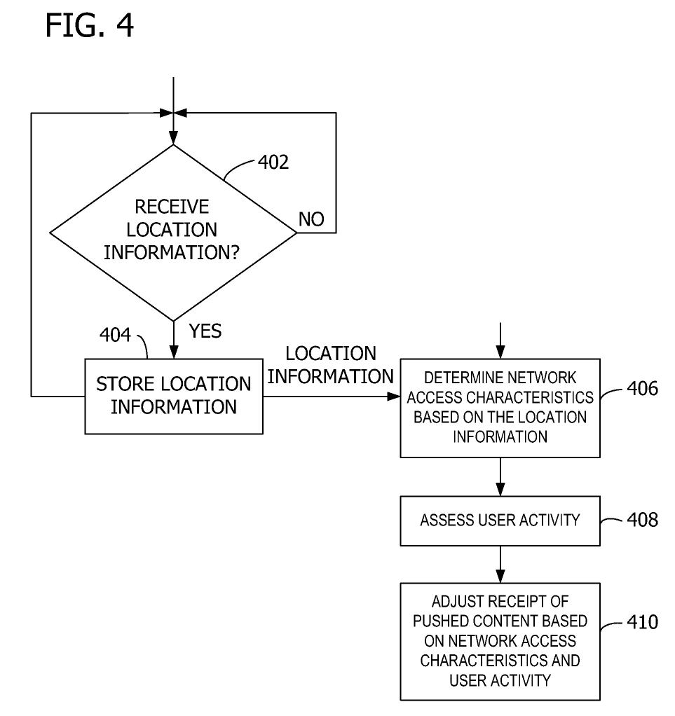

Responsive to the predicted network access event and/or the predetermined cost, the application programs 103 adjust or modify delivery of the pushed content or other resource access as described in greater detail below with reference to FIG. 3 and FIG. 4.

The processor 204 includes any quantity of processing units, and is programmed to execute computer-executable instructions for implementing aspects of the disclosure. The instructions may be performed by the processor 204 or by multiple processors executing within the computing device 102, or performed by a processor external to the computing device 102 (e.g., by a cloud service). In some embodiments, the processor 204 is programmed to execute instructions such as those illustrated in the figures (e.g., FIG. 3 and FIG. 4).

Referring next to FIG. 3, an exemplary flow chart illustrates application programs 103 modifying delivery of pushed content based on a predicted network event. The operations illustrated in FIG. 3 and FIG. 4 are performed in some embodiments by executable code on the computing device 102. In other embodiments, one or more of the operations are performed by code executed by a processor remote from the computing device 102 (e.g., as in a cloud service embodiment). In such embodiments, the remote processor transmits the output of the performed operations to the computing device 102 to enable the application programs 103 executing thereon to adjust receipt of the pushed content.

At 302, the list 210 of the application programs 103 that receive pushed content is maintained. In some embodiments, the application programs 103 are not ordered within the list. In other embodiments, the application programs 103 are prioritized by, for example, the user 101. The priority may affect the ability of the application programs 103 to access resources in response to a predicted network event. For example, if the network access event will result in degraded access, the lower priority application programs 103 are denied access before the higher priority application programs 103 are denied access.

At 304, user interaction with the computing device 102 is detected, assessed, or otherwise monitored. For example, any user input and a frequency of the input are monitored. Processor load or any other performance metric for the computing device 102 may also be monitored. The user activity may be categorized or assigned a label based on the monitored amount or frequency of the user input. For example, if the user 101 has not recently interacted with the computing device 102 (e.g., within the last three minutes), the user 101 or computing device 102 is considered to be “idle.” Otherwise, the user 101 or computing device 102 is considered “active.”

Further, the user interaction may be defined based on detected motion or movement of the user 101 (e.g., active), or lack of detected movement (e.g., idle). For example, the user 101 may be carrying the computing device 102 and moving in a particular direction.

At 306, a network access event is predicted based on the user interaction and location information 208 for the computing device 102. The location information 208 is determined by the computing device 102, or received or obtained from a location information service provider. The location information 208 may include data from a global positioning system (GPS), cellular tower locations, network access points, or any other location-aware information provider. For example, the network access event may include one or more of the following: an expected loss of network access, an expected establishment of a connection to the network 108, and an expected modification of parameters for connecting to the network 108. The network access event is predicted by, for example, the location of the cellular network towers, known coverage areas (e.g., as provided by wireless service providers), user-specified points of interest or boundaries, or known areas of connectivity failure.

The network access event may also be predicted based on the detected motion or movement of the user 101. Given the location information 208 and the detected motion, embodiments of the disclosure predict when the computing device 102 will lose connectivity (prompting application programs 103 to retrieve content prior to the loss of connectivity). Alternatively, if no motion is detected, embodiments of the disclosure predict that coverage will continue to be available (prompting application programs 103 to delay accessing the network 108 until the user 101 executes an application or turns on a display of the computing device 102.

At 308, the application programs 103 in the list 210 of application programs 103 registered to receive pushed content are notified of the predicted network access event. For example, the application programs 103 are provided with the notification and a time value. The time value represents the amount of time before occurrence of the predicted network access event (e.g., in minutes or seconds). At 310, in response to being notified of the predicted network access event, the application programs 103 communicate with the network 108 (e.g., the content providers 104 or other resources) to modify delivery of the pushed content. For example, the application programs 103 may instruct the content providers 104 to postpone delivery of the pushed content when the predicted network access event occurs, or request additional content before the predicted network access event occurs. Alternatively or in addition, the application programs 103 respond to the notification by asking the computing device 102 to decline or delete any pushed content received subsequently on behalf of the application programs 103.

Referring next to FIG. 4, an exemplary flow chart illustrates the computing device 102 adjusting receipt of pushed content based on current network access characteristics. If the location information 208 is received at 402, the received location information 208 is stored at 404 in the memory area 206. In some embodiments, the computing device 102 continually receives location information 208 from a location information service provider or a location-based information retrieval system. In other embodiments (not shown), the computing device 102 retrieves the location information 208 from the location information service provider on request. Exemplary location information 208 includes, but is not limited to, a location of the computing device 102, a location of a landmark, a point-of-interest, a location of an airport, or a location of a network access point.

At 406, network access characteristics are determined based at least on the location information 208 for the computing device 102. The network access characteristics are determined by the computing device 102 or any other device or component, local or remote from the computing device 102. The network access characteristics include, but are not limited to, a signal strength, a connection type, an expected loss of network access, an expected establishment of a connection to the network 108, or an expected modification of parameters for connecting to the network 108. However, the network access characteristics include any measurement, characteristic, status, or descriptor of the connection.

In some embodiments, the network access characteristics are determined (e.g., by the computing device 102) based on location information 208 that is derived at least in part from crowd-sourced location data. The crowd-sourced location data includes data that has been submitted by other users 101 or devices to a device such as the computing device 102 or the location information service provider. The submitted location data is collected and processed into the location information 208. Exemplary crowd-sourced location data includes data that is collected and submitted by users 101 with mobile computing devices.

User activity on the computing device 102 is assessed at 408. Receipt of the pushed content is adjusted at 410 based on the assessed user activity and the determined network access characteristics. In some embodiments, the computing device 102 adjusts receipt for each of the application programs 103 that execute on the computing device 102 to receive the pushed content. For example, the computing device 102 disables receipt or delivery of the pushed content by sending a request to the network 108 or to one or more of the content providers 104. In another example, the computing device 102 requests that delivery of the content be postponed, batched, or scheduled to reduce a frequency of delivery. The computing device 102 may also request that receipt or delivery of the pushed content be subsequently re-enabled, or the delivery schedule be re-adjusted.

### Exemplary Operating Environment

By way of example and not limitation, computer readable media comprise computer storage media and communication media. Computer storage media store information such as computer readable instructions, data structures, program modules or other data. Communication media typically embody computer readable instructions, data structures, program modules, or other data in a modulated data signal such as a carrier wave or other transport mechanism and include any information delivery media. Combinations of any of the above are also included within the scope of computer readable media.

Although described in connection with an exemplary computing system environment, embodiments of the invention are operational with numerous other general purpose or special purpose computing system environments or configurations. Examples of well known computing systems, environments, and/or configurations that may be suitable for use with aspects of the invention include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

Aspects of the invention transform a general-purpose computer into a special-purpose computing device when configured to execute the instructions described herein.

The embodiments illustrated and described herein as well as embodiments not specifically described herein but within the scope of aspects of the invention constitute exemplary means for modifying delivery of the pushed content based on the location information 208 for the mobile computing device and the user interaction with the mobile computing device, and exemplary means for correlating the location information 208 for the mobile computing device with an ability of the mobile computing device to access remote resources.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system for adapting resource retrieval based on device location and user interaction, said system comprising:
a memory area for storing location information for a mobile computing device connected to a network, said memory area further storing a list of application programs receiving pushed content from the network; and
a processor programmed to:
maintain, in the memory area, the list of application programs that receive the pushed content;
detect user interaction with the mobile computing device;
predict a network access event based on the detected user interaction and the location information stored in the memory area; and
send a notification conveying the predicted network access event to the application programs in the list of application programs stored in the memory area, wherein the application programs communicate with the network to modify receipt of the pushed content responsive to the predicted network access event.

2. The system of claim 1, wherein the network access event comprises one or more of the following: an expected loss of network access, an expected establishment of a connection to the network, and an expected modification of parameters for connecting to the network.

3. The system of claim 1, wherein the network comprises a front-end server pushing the content to the mobile computing device.

4. The system of claim 1, wherein the application programs modify receipt of the pushed content by communicating with the network to postpone delivery of the pushed content.

5. The system of claim 1, wherein the application programs modify receipt of the pushed content by:
determining a cost associated with receipt of the pushed content; and
modifying receipt of the pushed content based on the determined cost.

6. The system of claim 5, wherein modifying receipt of the pushed content based on the determined cost comprises requesting additional pushed content when the determined cost is less than a predefined threshold.

7. The system of claim 1, further comprising means for modifying delivery of the pushed content based on the location information for the mobile computing device and the user interaction with the mobile computing device.

8. The system of claim 1, further comprising means for correlating the location information for the mobile computing device with an ability of the mobile computing device to access remote resources.

9. A method comprising:
receiving, by a computing device, location information for the computing device connected to a network, said network pushing content to the computing device;
assessing user activity on the computing device;
determining, by the computing device, network access characteristics based at least on the received location information; and
adjusting receipt of the content pushed to the computing device based on the determined network access characteristics and the assessed user activity.

10. The method of claim 9, wherein adjusting receipt of the content comprises sending a request to a content provider computing device to disable delivery of the content to the computing device or enable delivery of the content to the computing device.

11. The method of claim 9, wherein adjusting receipt of the content comprises sending a request to the content provide computing device to batch the pushed content for delivery to the computing device to reduce a frequency of delivery.

12. The method of claim 9, wherein receiving the location information comprises receiving one or more of the following data: a location of the mobile computing device, a location of a landmark, a point-of-interest, a location of an airport, and a location of a network access point.

13. The method of claim 9, wherein determining the network access characteristics comprises determining one or more of the following: a signal strength, a connection type, an expected loss of network access, an expected establishment of a connection to the network, and an expected modification of parameters for connecting to the network.

14. The method of claim 9, wherein assessing user activity comprises detecting movement of the computing device.

15. The method of claim 9, further comprising receiving crowd-sourced location data, wherein determining the network access characteristics comprises determining the network access characteristics based on the received crowd-sourced location data.

16. One or more computer-readable media having computer-executable components, said components comprising:
an interface component that when executed by at least one processor causes the at least one processor to receive location information for a computing device connected to a network, said network pushing content to the computing device;
a state component that when executed by at least one processor causes the at least one processor to monitor user interaction with the computing device;
a connection component that when executed by at least one processor causes the at least one processor to predict a network access event based on the received location information and the monitored user interaction; and
a registration component that when executed by at least one processor causes the at least one processor to notify one or more application programs of the network access event predicted by the connection component, said one or more application programs executing on the computing device to receive the pushed content, wherein the notified application programs communicate with the network to adjust the receipt of the pushed content responsive to the predicted network access event.

17. The computer-readable media of claim 16, wherein the registration component maintains a list of the application programs that receive the pushed content.

18. The computer-readable media of claim 16, wherein the state component transitions the computing device between an active state and an inactive state based on the monitored user interaction.

19. The computer-readable media of claim 16, wherein the connection component further determines a cost associated with receipt of the pushed content by the computing device, and wherein the registration component notifies said one or more applications of the cost determined by the connection component.

20. The computer-readable media of claim 19, wherein the connection component compares the determined cost with a predefined threshold to predict the network access event.
